(19) United States
(12) Patent Application Publication
(10) Pub. No.: US 2007/0025535 A1
(43) Pub. Date: Feb. 1, 2007

(54) Measuring and improving customer satisfaction at automated customer service centers

(75) Inventors: Robert Bushey, Cedar Park, TX (US); Ben Knott, Round Rock, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/178,778

(22) Filed: Jul. 11, 2005

(51) Int. Cl. H04M 3/42

(52) U.S. Cl. 379/201.03

(57) ABSTRACT

A quality evaluation system (100) has a communications interface (110) coupled to one or more service centers (120, 130), a memory (104), and a processor (102). The processor is programmed to monitor (204) customer interactions with one or more dialogs of each service center, correlate (206) customer interactions with customer surveys collected at each service center, and adjust (212) one or more dialogs at each service center according to the correlated customer interactions.

### FIELD OF THE INVENTION

This invention relates generally to quality evaluation systems, and more particularly to a method and apparatus for measuring and improving customer satisfaction at automated customer service centers.

### BACKGROUND OF THE INVENTION

It has become common place for service providers to provide customer support services by way of automated interactive voice response systems and/or websites tailored for supporting customer needs. Customer satisfaction relative to the use of such systems depends strongly on the design of dialog modules that address customer needs.

When dialog modules are designed poorly, customers tend to struggle getting the help they need and consequently become frustrated with the service. In addition, as service technologies evolve, customers' needs change. Under such circumstances, a well designed automated customer service center that does not detect such change in technology can become obsolete and a source of frustration for customers.

Accordingly, a need arises for a method and apparatus for measuring and improving customer satisfaction at automated customer service centers.

### SUMMARY OF THE INVENTION

Embodiments in accordance with the invention provide a method and apparatus for measuring and improving customer satisfaction at automated customer service centers.

In a first embodiment of the present invention, a quality evaluation system has a communications interface coupled to one or more service centers, a memory, and a processor. The processor is programmed to monitor customer interactions with one or more dialogs of each service center, correlate customer interactions with customer surveys collected at each service center, and adjust one or more dialogs at each service center according to the correlated customer interactions.

In a second embodiment of the present invention, a computer-readable storage medium in a quality evaluation system has computer instructions for monitoring customer interactions with one or more dialogs of each service center, correlating customer interactions with customer surveys collected at each service center, and adjusting one or more dialogs at each service center according to the correlated customer interactions.

In a third embodiment of the present invention, a quality evaluation system operates according to a method having the steps of monitoring customer interactions with one or more dialogs of each service center, correlating customer interactions with customer surveys collected at each service center, and adjusting one or more dialogs at each service center according to the correlated customer interactions.

### BRIEF DESCRIPTION OF THE DRAWINGS

FIG. 1 is block diagram of a quality evaluation system according to an embodiment of the present invention;

FIG. 2 depicts a flowchart of a method operating in the quality evaluation system according to an embodiment of the present invention; and

FIG. 3 is a diagram depicting customer satisfaction in relation to customer interactions according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

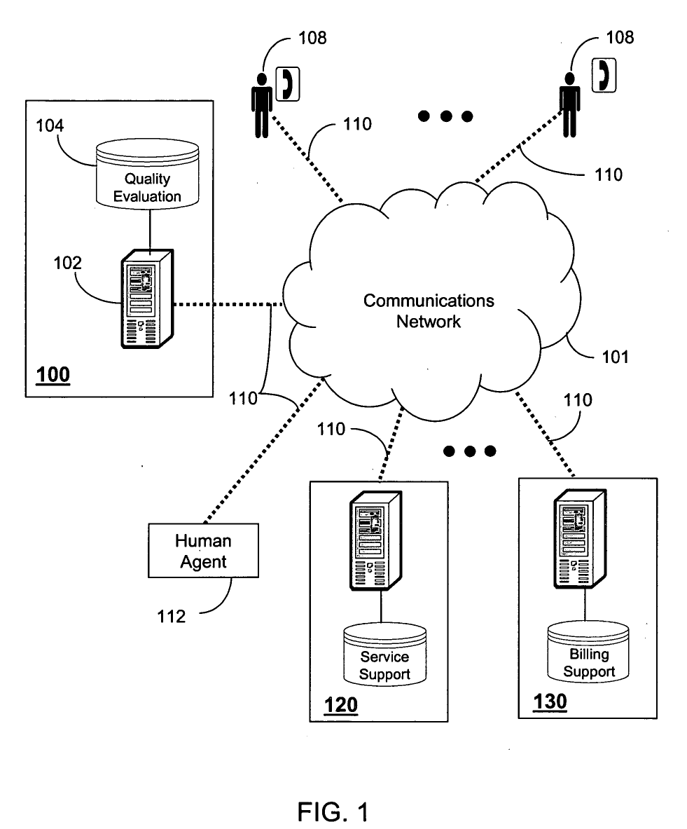

FIG. 1 is block diagram of a quality evaluation system (QES) 100 according to an embodiment of the present invention. The QES 100 comprises a communications interface 110, a memory 104 and a processor 102. The communications interface 110 utilizes conventional wired or wireless communications technology for interfacing to the communications network 101. The communications interface 110 can represent a circuit switched and/or a packet switched interface. Internet and/or traditional voice services can be provided by network 101 to customers 108. Thus, the communications network 101 can support multiple services such as: VoIP (Voice over Internet communications, IPTV (Internet Protocol Television), broadband communications, cellular telephony, and other known or future communication services.

The processor 102 utilizes conventional computing technology such as a desktop computer, or a scalable server. The memory 104 utilizes conventional mass storage media such as a high capacity disk drive, and can be used by the processor 102 to manage a database in accordance with the present invention. The QES 100 can also use conventional applications such as a CRM (Customer Relations Management) application for managing communication dialogs utilized by the automated service centers such as shown in references 120 and 130.

By way of the communications interface 110, the QES 100 can access independently operated remote automated service centers such as an automated service support center 120 and/or an automated billing support center 130 among others. The automated service support center 120 can, for example, assist customers who need help understanding how to use a service procured by the customer from the service provider.

Centers 120 and 130 can use automation applications such as an IVR (Interactive Voice Response) system, and/or a website application for serving customers needs without a human customer service agent 112. Consequently, a service provider can provide a variety of support services on a twenty-four hour basis at nominal cost when compared to a collection of human agents. In accordance with aspects of the present invention, the QES 100 can perform updates on customer dialogs operating in the automated service centers 120 and 130. It will be appreciated that in the alternative that systems 120 and 130 can be in whole or in part an integral part of the QES 100, or the QES 100 functionality can be programmed into each of systems 120 and 130, respectively. It will also be appreciated that automated systems 120 and 130 are but a few of many automated system applications that can be applied to the present invention. It would be obvious therefore that other automated systems that can be managed by a QES 100 are within the scope and spirit of the claimed invention.

The communication network 101 in the present illustration represents an embodiment of a service enterprise that the QES 100 can support in accordance with the present invention. It will become exceedingly obvious to an artisan with skill in the art from the descriptions below that other service enterprises for which customers can request support in relation to services offered to said customers can utilize the present invention, and is therefore within the scope and spirit of the claims below.

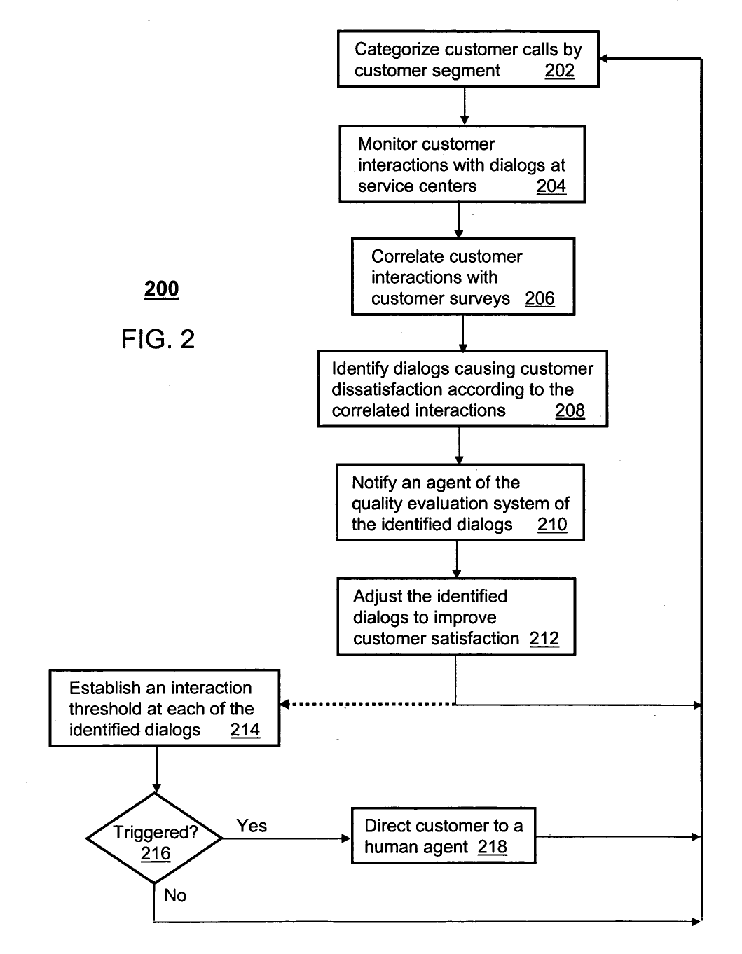

FIG. 2 depicts a flowchart of a method 200 operating in the QES 100 according to an embodiment of the present invention. Method 200 begins with step 202 where the QES 100 is programmed to categorize customer calls by customer segment. A customer segment in the present context can have innumerable meanings. For example, a customer segment can represent any demographic or psychographic segmentation of customers which the service provider of the QES 100 can derive from information either known to the service provider (e.g., a customer account, marketing information derived therefrom), or information provided by the customer (e.g., caller ID), which can be used to derive a segmentation profile of the customer. In an alternative embodiment, segmentation can be disregarded in steps 202 through 208, thereby applying the present invention generically to all customers. For the present illustration, however, segmentation can be utilized as a supplemental means to improve customer satisfaction.

With this in mind, in step 204 the QES 100 monitors by customer segment customer interactions with dialogs at service centers 120 and/or 130. Customer interactions can be measured by, for example, the number of turns a customer experiences in navigating through a dialog module of a service center. For example, a dialog module might query a customer for her account number or other form of identification followed by service support options provided to the customer for selection. If the identification query is completed successfully in one interactive step, then one turn is recorded. If the service center cannot recognize the customer's response, or the customer does not respond within a timeout period, then a turn is recorded in this instance. Since in the latter example the customer has to attempt again to convey an identification a second iteration will be recorded.

Each dialog can have a predicted number of customer interactions (turns). If there is an unsuccessful customer interaction, additional turns will be recorded. Each turn is recorded in step 204 until the customer transitions to the next dialog. Additionally, each automated service center can have as many dialogs as deemed necessary for supporting customer needs. These dialogs can be defined in any hierarchy suitable to the invention.

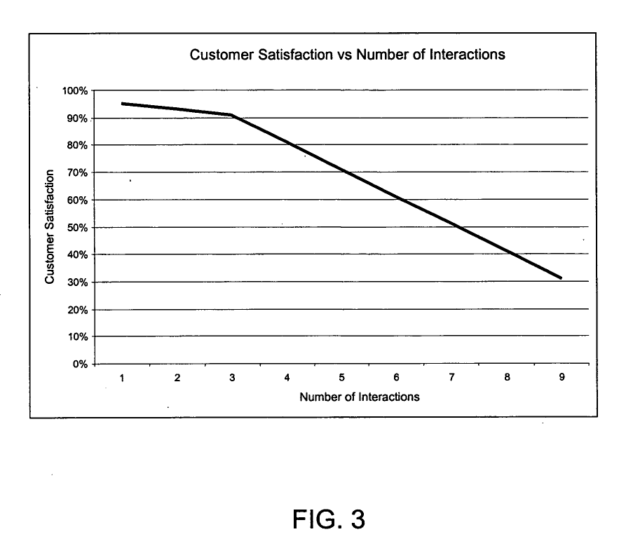

Once the customer iterations have been recorded for each dialog, in step 206 the QES 100 correlates by segment the customer interactions with customer surveys. Customer surveys, for example, can be applied randomly or selectively by the automated service centers 120 and 130 to assess customer satisfaction in using the automated support service. The surveys can be designed to query the customer for a satisfaction rating for each of the dialogs used by the customer or a limited subset. The survey information along with the corresponding recorded customer interactions by dialog can be collected on a number of customers to produce a diagram depicting customer satisfaction in relation to customer interactions as shown in FIG. 3. Such a relationship can be recorded for each dialog, or across a number of dialogs of a particular subsystem of an automated service center.

A diagram such as shown in FIG. 3 can be used to assess the performance dialogs in automated service centers. In the present illustration, it is clear that after three customer interactions (turns) customer satisfaction drops rapidly. The service provider of the QES 100 can establish from this measurement a policy whereby any dialogs exceeding more than an average of three turns should be updated.

From such a policy, the QES 100 can be programmed in step 208 to identify dialogs which may be causing customer dissatisfaction on the basis of the correlated interactions. The QES 100 can then proceed to notify an agent of the QES 100 of the identified dialogs which may be causing customer satisfaction issues. Notification can by provided over any suitable communication medium (e.g., email, over-the-air wireless message, etc.).

In step 212, the QES 100 can be programmed to adjust the identified dialogs to improve customer satisfaction. The QES 100 can perform this step by, for example, reviewing the customer interactions of a particular suspect dialog, identifying a potential root cause for the excessive interactions, and take remedial measures to improve the interactions. This may be accomplished by the QES 100 selecting from available library dialog functions which provide flexibility to manipulate the dialog interaction with the customer. In a less sophisticated setting, the dialog can be reprogrammed by an agent of the QES 100.

In a supplemental embodiment, the QES 100 can also be programmed in step 214 to establish an interaction threshold (e.g., no more than three turns) at each of the identified dialogs. This threshold can be applied by customer segment (e.g., only important business or premium customers) or for all customers independent of their value to the service provider. If in step 216, the QES 100 determines that a customer has exceeded the threshold of a particular dialog, then the automated service center can be directed to transfer the customer to a human agent in step 218. Otherwise, another cycle of method 200 is repeated.

Each time the QES 100 repeats the aforementioned steps, it can determined if adjustments made in step 212 and 214 were effective in improving customer satisfaction. If not, the QES 100 can make further attempts on its own or with the assistance of a QES 100 agent.

It should be evident by now that the present invention can be realized in hardware, software, or a combination of hardware and software. Moreover, the present invention can be realized in a centralized fashion, or in a distributed fashion where different elements are spread across several interconnected processors. Thus, any kind of computing device or other apparatus adapted for carrying out method 200 described above is suitable for the present invention.

It should be also evident that the present invention may be used for many applications. Thus, although the description is made for particular arrangements and methods, the intent and concept of the invention is suitable and applicable to other arrangements and applications not described herein. It would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein. A software program in the present context means any expression, in any language, code or notation, of a set of instructions intended to cause a system having an information processing capability to perform a particular function either directly or after either or both of the following: a) conversion to another language, code or notation; b) reproduction in a different material form.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A quality evaluation system, comprising:
a communications interface coupled to one or more service centers;
a memory; and
a processor, wherein the processor is programmed to:
monitor customer interactions with one or more dialogs of each service center;
correlate customer interactions with customer surveys collected at each service center; and
adjust one or more dialogs at each service center according to the correlated customer interactions.

2. The quality evaluation system of claim 1, wherein the processor is programmed to identify one or more dialogs causing customer dissatisfaction according to the correlated interactions.

3. The quality evaluation system of claim 2, wherein the processor is programmed to notify an agent of the quality evaluation system of the identified dialogs.

4. The quality evaluation system of claim 2, wherein the processor is programmed to adjust the identified dialogs to improve customer satisfaction.

5. The quality evaluation system of claim 2, wherein the processor is programmed to establish an interaction threshold at each of the identified dialogs for triggering a transfer of a customer to a human agent when said threshold is reached by the customer.

6. The quality evaluation system of claim 1, wherein the processor is programmed to:
categorize customer calls by customer segment;
monitor customer interactions by customer segment; and
correlate customer interactions with customer surveys by customer segment.

7. The quality evaluation system of claim 6, wherein the processor is programmed to identify one or more dialogs causing customer dissatisfaction by customer segment according to the correlated interactions.

8. The quality evaluation system of claim 7, wherein the processor is programmed to notify an agent of the quality evaluation system of the identified dialogs by customer segment.

9. The quality evaluation system of claim 7, wherein the processor is programmed to adjust the identified dialogs for customer segments to improve customer satisfaction.

10. The quality evaluation system of claim 7, wherein the processor is programmed to establish an interaction threshold by customer segment at each of the identified dialogs for triggering a transfer of a customer to a human agent when said threshold is reached by the customer.

11. The quality evaluation system of claim 1, wherein dialogs comprise one among speech interactions and webpage interactions.

12. A computer-readable storage medium in a quality evaluation system, comprising computer instructions for:
monitoring customer interactions with one or more dialogs of each service center;
correlating customer interactions with customer surveys collected at each service center; and
adjusting one or more dialogs at each service center according to the correlated customer interactions.

13. The storage medium of claim 12, comprising computer instructions for identifying one or more dialogs causing customer dissatisfaction according to the correlated interactions.

14. The storage medium of claim 13, comprising computer instructions for notifying an agent of the quality evaluation system of the identified dialogs.

15. The storage medium of claim 13, comprising computer instructions for adjusting the identified dialogs to improve customer satisfaction.

16. The storage medium of claim 13, comprising computer instructions for establishing an interaction threshold at each of the identified dialogs for triggering a transfer of a customer to a human agent when said threshold is reached by the customer.

17. The storage medium of claim 12, comprising computer instructions for:
categorizing customer calls by customer segment;
monitoring customer interactions by customer segment; and
correlating customer interactions with customer surveys by customer segment.

18. The storage medium of claim 17, comprising computer instructions for identifying one or more dialogs causing customer dissatisfaction by customer segment according to the correlated interactions.

19. The storage medium of claim 18, comprising computer instructions for at least one among:
notifying an agent of the quality evaluation system of the identified dialogs by customer segment;
adjusting the identified dialogs for customer segments to improve customer satisfaction; and
establishing an interaction threshold by customer segment at each of the identified dialogs for triggering a transfer of a customer to a human agent when said threshold is reached by the customer.

20. In a quality evaluation system, a method comprising the steps of:
monitoring customer interactions with one or more dialogs of each service center;
correlating customer interactions with customer surveys collected at each service center; and
adjusting one or more dialogs at each service center according to the correlated customer interactions.
